(19) United States
(12) Patent Application Publication
(10) Pub. No.: US 2007/0124937 A1
(43) Pub. Date: Jun. 7, 2007

(54) HEAD TILTING DEVICE OF ELECTRIC SHAVER

(76) Inventor: Tae-Jun OH, Namyangju-shi (KR)

Correspondence Address: CANTOR COLBURN, LLP, 55 GRIFFIN ROAD SOUTH, BLOOMFIELD, CT, 06002, US

(21) Appl. No.: 11/565,761

(22) Filed: Dec. 1, 2006

(30) Foreign Application Priority Data
Dec. 2, 2005 (KR) 2020050034046

(51) Int. Cl. B26B 19/04

(52) U.S. Cl. 30/43.92; 30/527

(57) ABSTRACT

Disclosed is a head tilting device of a slim electric shaver, which allows the electric shaver to be easily carried about when it is not used and a head to tilt from a housing when it is used. The head tilting device includes hinge pins formed at right and left sides of a head and connected to head supporters formed in a pair on right and left sides of the upper end of a housing for guiding the swing motion of the head; a lid installed on the housing for covering the head; slide pins formed on the upper end of a folding piece, the lower end of which is connected to a switch knob sliding up and down on the housing, and slidingly inserted into a T-type groove formed through the lower end of the central portion of the head; a swing arm installed at a pivot traversing support pieces formed on the housing, the upper end of the swing arm being protruded from the upper portion of the housing and being slidingly inserted into a trimmer groove of a trimmer unit exposed from the rear portion of the head; and an eccentric shaft installed on a motor shaft of a driving motor and slidingly inserted into a clevis groove formed in the lower end of the swing arm.

### BACKGROUND OF THE INVENTION

1. Field of the Invention

The present invention relates to a head tilting device of a slim electric shaver, and more particularly to a head tilting device of a slim electric shaver, which, when it is not used, allows the electric shaver to maintain a slim shape and thus to be easily carried about, and, when it is used, allows a head to tilt from a housing by switch manipulation and thus to be convenient for use.

2. Description of the Related Art

Generally, electric shavers are divided into trimming shavers, each of which shaves a user's face by a reciprocating blade, and rotary shavers, each of which shaves a user's face by a rotating blade.

In each of the conventional electric shavers, all portions of a screen of a head contacting a user's face turn upward. Accordingly, the conventional electric shavers are limited in thickness, thus being not easily carried about.

### SUMMARY OF THE INVENTION

Therefore, the present invention has been made in view of the above problems, and it is an object of the present invention to provide a head tilting device of a slim electric shaver, which is easily carried about.

In accordance with the present invention, the above and other objects can be accomplished by the provision of a head tilting device of a slim electric shaver, comprising hinge pins formed at right and left sides of a head and connected to head supporters formed in a pair on right and left sides of the upper end of a housing for guiding the swing motion of the head; a lid installed on the housing for covering the head; slide pins formed on the upper end of a folding piece, the lower end of which is connected to a switch knob sliding up and down on the housing, and slidingly inserted into a T-type groove formed through the lower end of the central portion of the head; a swing arm installed at a pivot traversing support pieces formed on the housing, the upper end of the swing arm being protruded from the upper portion of the housing and being slidingly inserted into a trimmer groove of a trimmer unit exposed from the rear portion of the head; and an eccentric shaft installed on a motor shaft of a driving motor and slidingly inserted into a clevis groove formed in the lower end of the swing arm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a head portion having a head tilting device of a slim electric shaver in accordance with the present invention;

FIG. 2 is an exploded perspective view of a switch knob and the head portion having the head tilting device in accordance with the present invention;

FIG. 3 is a longitudinal sectional view of the head tilting device in accordance with the present invention;

FIG. 4 is a longitudinal sectional view of the head tilting device in accordance with the present invention, in a state in which a lid is opened and a head tilts; and

FIG. 5 is an enlarged sectional view of the head portion of the slim electric shaver in accordance with the present invention.

### DESCRIPTION OF THE PREFERRED EMBODIMENTS

Now, a preferred embodiment of the present invention will be described in detail with reference to the annexed drawings.

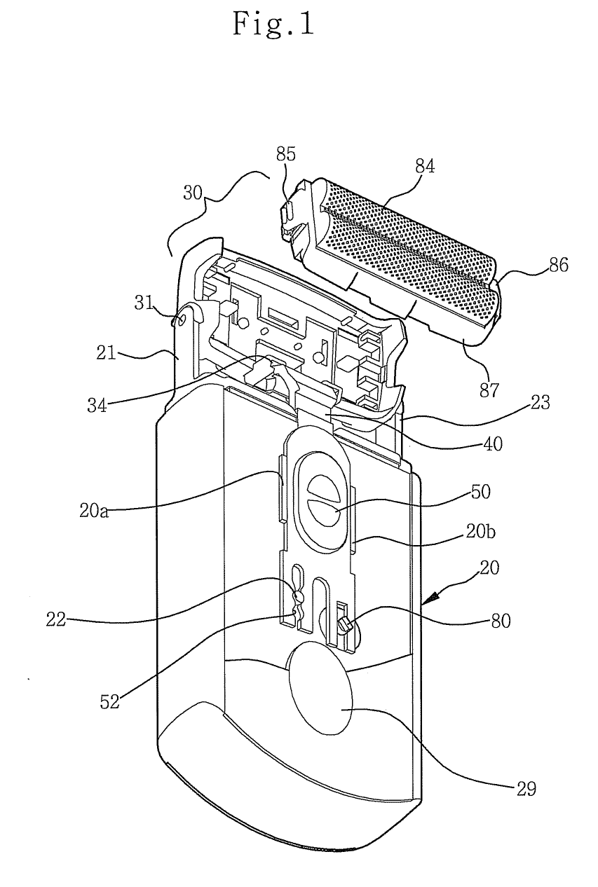

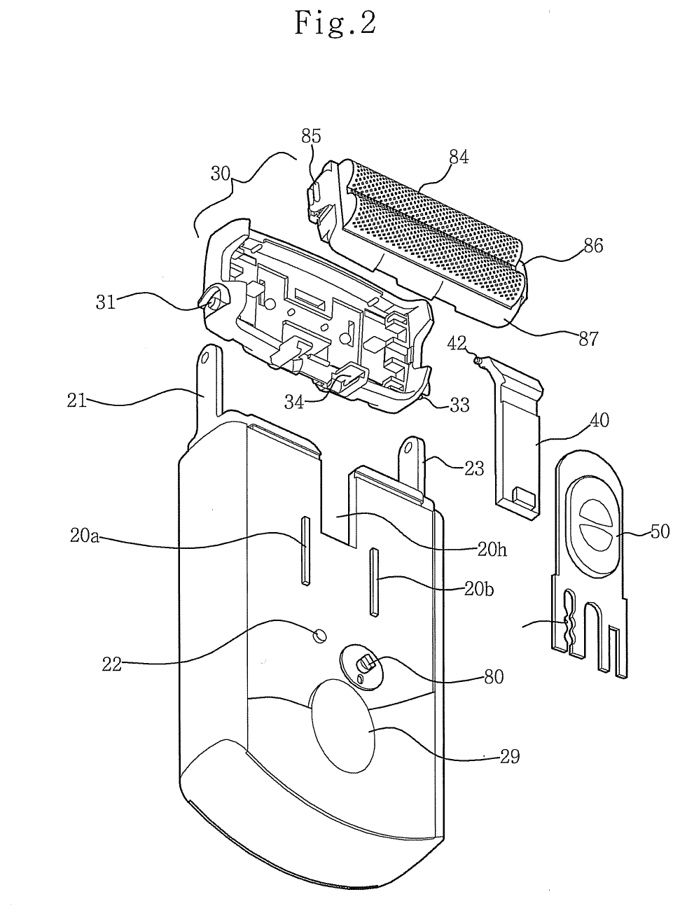

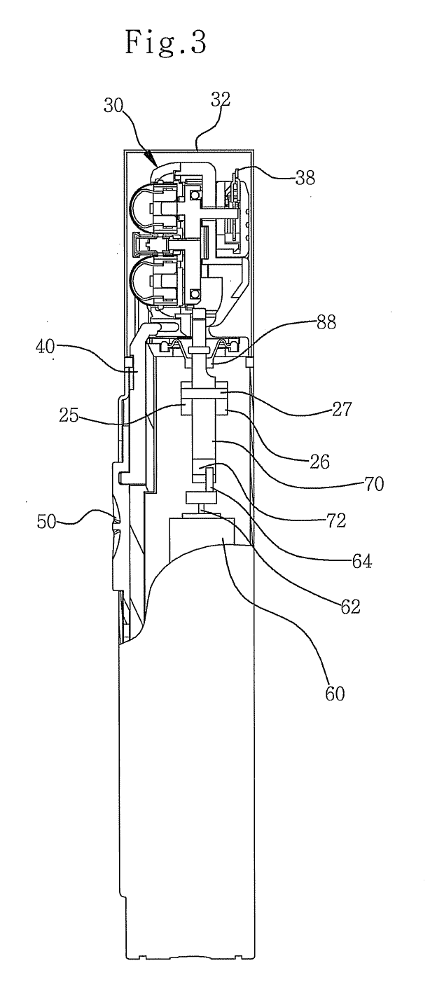

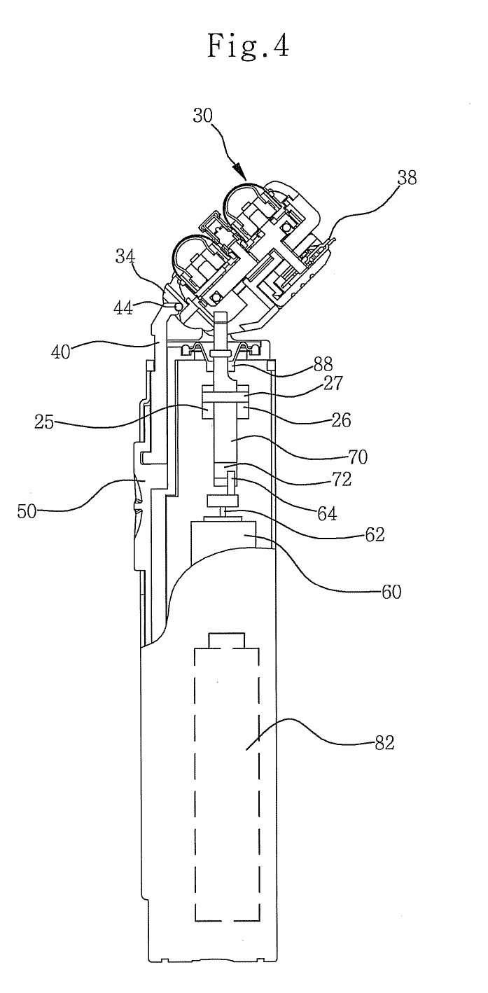

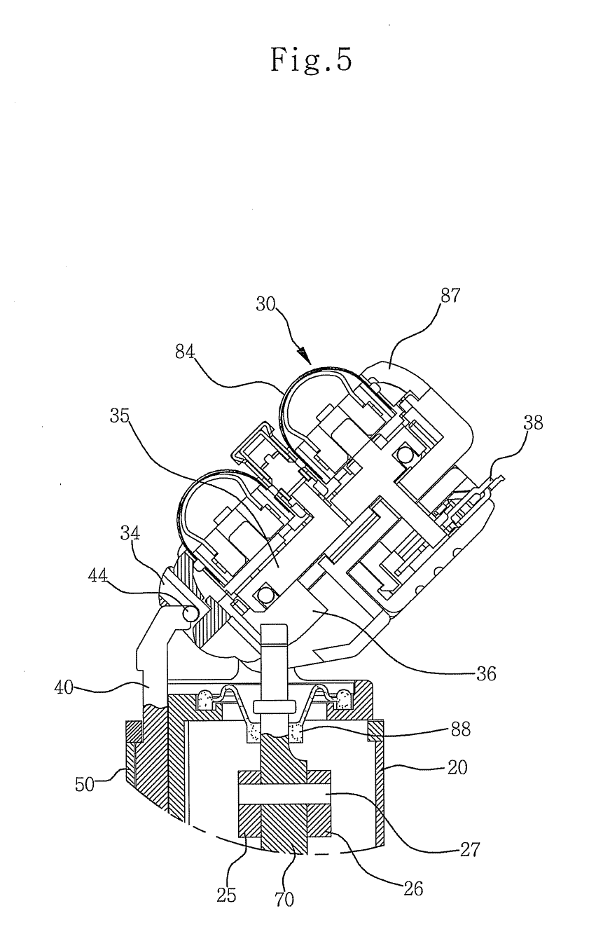

As shown in FIGS. 1 to 5, hinge pins 31 and 33, which are connected to head supporters 21 and 23 formed in a pair on right and left sides of the upper end of a housing 20 and guide the swing motion of a head 30, are formed at right and left sides of the head 30. A lid 32 for covering the head 30 is installed on the housing 20. Slide pins 42 and 44 formed on the upper end of a folding piece 40 are slidingly inserted into a T-type groove 34, which is formed through the lower end of the central portion of the head 30. The lower end of the folding piece 40 is connected to a switch knob 50, which slides up and down on the housing 20. A swing arm 70 is installed at a pivot 27 traversing support pieces 25 and 26 formed on the housing 20. The upper end of the swing arm 70 is protruded from the upper portion of the housing 20, and is slidingly inserted into a trimmer groove 36 of a trimmer unit 35 exposed from the rear portion of the head 30. An eccentric shaft 64 installed on a motor shaft 62 of a driving motor 60 is slidingly inserted into a clevis groove 72 formed in the lower end of the swing arm 70.

A screen frame 87 formed along the edge of a screen 84 is installed on the front surface of the head 30, and elastic fastening pieces 85 and 86 are installed at right and left sides of the screen frame 87, thus causing the screen 84 and the trimmer unit 35 formed therein to be connected to or disconnected from the head 30.

The switching knob 50 is rectilinearly guided up and down by guide ribs 20a and 20b, which are formed in parallel on the front surface of the housing 20.

A position determining boss 22 is formed on the front surface of the housing 20, and a wave-type long hole 52, to which the position determining boss 22 is connected, is formed through the switch knob 50, thereby determining the angle of the head 30 in stages according to the vertical position of the switch knob 50. An opening 20h, into which the folding piece 40 is inserted, is formed through the central portion of the upper end of the housing 20.

A side trimmer 38 for trimming long hairs is installed on the rear surface of the head 30, and moves together with the movement of the head 30.

Here, reference numeral 29 represents a liquid crystal display unit installed on the front surface of the housing 20, reference numeral 80 represents a power switch, reference numeral 82 represents a charging battery, and reference numeral 88 represents a waterproof rubber packing.

Hereinafter, the function of the head tilting device of the present invention will be described in detail with reference to the annexed drawings.

As shown in FIGS. 1 to 5, the lid 32 connected to the housing 20 is opened, and the switch knob 50 installed on the front surface of the housing 20 is pushed upwardly. Then, the folding piece 40 connected to the upper end of the switch knob 50 moves upwardly together with the movement of the switch knob 50, and simultaneously, the slide pins 42 and 44 installed at the upper end of the folding piece 40 slide from the T-type groove 34 formed in the center of the head 30 and apply force to the head 30 upwardly.

Since the head 30 is hinged to the head supporters 21 and 23 formed on the upper portion of the housing 20 by the hinge pins 31 and 33, the head 30 turns centering on the hinge pins 31 and 33 and tilts rearward.

When the switch knob 50 is pushed upwardly as described above, the wave-type long hole 52 formed through the switch knob 50 is connected to the position determining boss 22 formed on the front surface of the housing 20 in stages, thereby determining the height of the switch knob 50 in stages. The higher the position of the switch knob 50 is, the higher the slope of the head 30 becomes.

Further, when the switch knob 50 is pushed upwardly, the switch knob 50 contacts the power switch 80 and a contact point of the power switch 80 is closed. Then, current flows from the charging battery 82 to the driving motor 60, thus rotating the driving motor 60. The eccentric shaft 64 connected to the motor shaft 62 of the driving motor 60 is rotated, and the swing arm 70 swings right and left centering on the pivot 27, thereby converting the rotary force generated from the driving motor 60 into a reciprocating motion. The reciprocating motion is transferred to the head 30.

When the head 30 tilts as described above, the trimmer groove 36 of the trimmer unit 35, into which the upper end of the swing arm 70 is slidingly inserted, has a long shape, which is extended in front and in the rear, thus not interfering with the swing arm 70.

In case that the electric shaver is folded and carried about by a person after use, when the switch knob 50 moves downwardly and is returned to its initial state, the contact point of the power switch 80 is opened, and a power supply line connected to the driving motor 60 is blocked, thus stopping the operation of the driving motor 60. Simultaneously, the folding piece 40 connected to the switching knob 50 moves downwardly together with the movement of the switching knob 50 and pulls the head 30 downwardly so that the head 30 lines up with the housing 20 in a straight line.

Thereafter, the lid 32 is connected to the housing 20. Then, the housing 20, the head 30, and the lid 32 form the slim electric shaver, which is easily carried about.

As apparent from the above description, the present invention provides a head tilting device of a slim electric shaver, thus allowing the electric shaver to be easily carried about. When a switch knob is pushed upwardly so as to use the electric shaver, a contact point is closed and a head tilts rearward. Accordingly, there is no necessity for moving the head through separate manipulation, thereby allowing the electric shaver to be conveniently used. Further, since a swing arm for transferring force, generated from a driving motor, to the head swings right and left centering on a pivot, the slim electric shaver has a simple structure, thus having high durability and lengthened life span.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A head tilting device of a slim electric shaver, comprising:
hinge pins formed at right and left sides of a head and connected to head supporters formed in a pair on right and left sides of the upper end of a housing for guiding the swing motion of the head;
a lid installed on the housing for covering the head;
slide pins formed on the upper end of a folding piece, the lower end of which is connected to a switch knob sliding up and down on the housing, and slidingly inserted into a T-type groove formed through the lower end of the central portion of the head;
a swing arm installed at a pivot traversing support pieces formed on the housing, the upper end of the swing arm being protruded from the upper portion of the housing and being slidingly inserted into a trimmer groove of a trimmer unit exposed from the rear portion of the head; and
an eccentric shaft installed on a motor shaft of a driving motor and slidingly inserted into a clevis groove formed in the lower end of the swing arm.

2. The head tilting device according to claim 1, wherein a position determining boss is formed on the front surface of the housing, and a wave-type long hole, which is connected to the position determining boss, is formed through the switch knob, thereby determining the angle of the head in stages according to the vertical position of the switch knob.
